(19) United States
(12) Patent Application Publication
(10) Pub. No.: US 2009/0274942 A1
(43) Pub. Date: Nov. 5, 2009

(54) POLAR PLATE, PARTICULARLY END PLATE OR BIPOLAR PLATE FOR A FUEL CELL

(76) Inventors: Andreas Reinert, Dresden (DE); Hans-Peter Baldus, Dresden (DE)

Correspondence Address: DICKINSON WRIGHT PLLC, 1875 Eye Street, NW, Suite 1200, WASHINGTON, DC, 20006, US

(21) Appl. No.: 12/296,605

(22) PCT Filed: Apr. 5, 2007
(86) PCT No.: PCT/DE07/00621

§ 371 Date: Jun. 26, 2009

(30) Foreign Application Priority Data
Apr. 10, 2006 (DE) 10 2006 016 814.3

(51) Int. Cl. H01M 8/02; H01M 8/10

(52) U.S. Cl. 429/30; 429/210

(57) ABSTRACT

The invention relates to a polar plate (10, 12), particularly an end plate (10) or a bipolar plate (12), for a fuel cell stack (14) comprising at least one flow field (16) accessible from at least one side of the polar plate (10, 12). In this connection it is, according to the invention, contemplated that the at least one flow field (16) is accessible via a plurality of access orifices (18).

The invention further relates to a termination unit and a repetitive unit for a fuel cell stack as well as a fuel cell stack.

The invention relates to a polar plate, particularly to an end plate or a bipolar plate, for a fuel cell comprising at least one flow field accessible from at least one side of the polar plate. The invention further relates to a termination and a repetitive unit for a fuel cell stack as well as to a fuel cell stack.

In SOFC fuel cell systems, for example, the fuel cell stack may consist of repetitive units stacked on top of each other as well as two termination units.

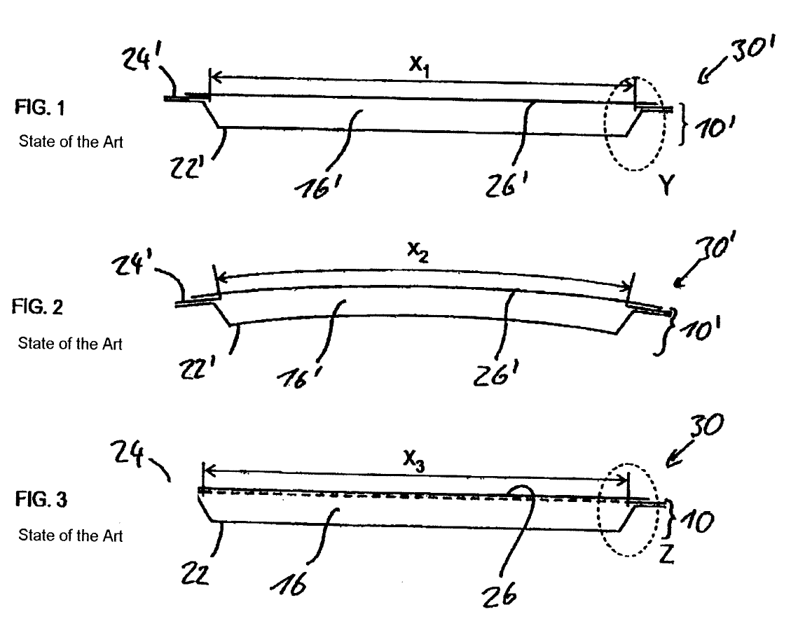

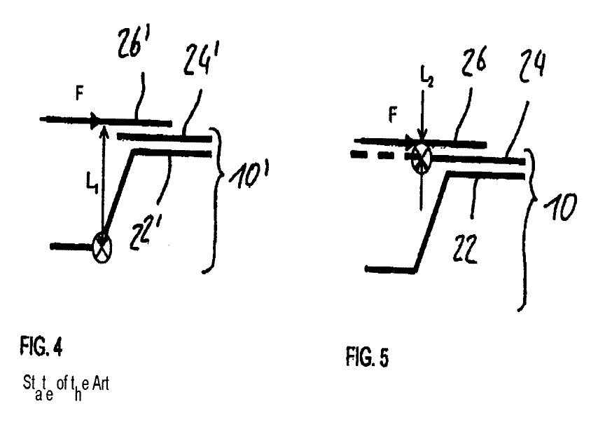

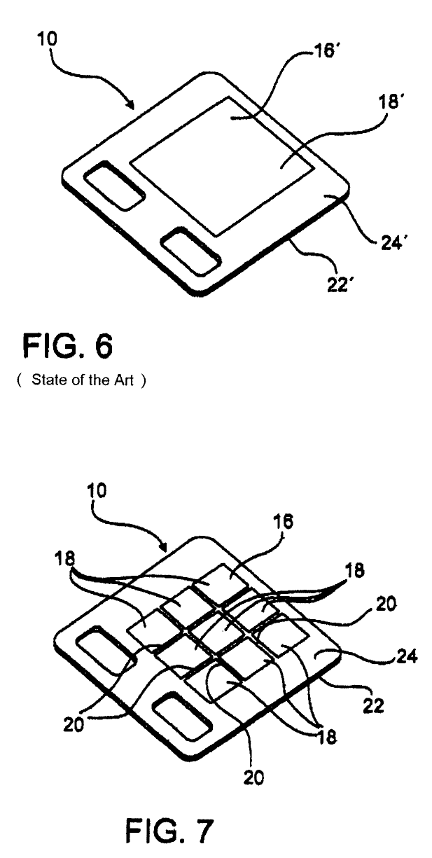

FIGS. 1, 2, 4 and 6 show a polar plate according to the state of the art, FIG. 1 showing a schematic cross sectional view of a polar plate, FIG. 2 the polar plate according to FIG. 1 deformed due to stresses, FIG. 4 the detail Y of FIG. 1 and FIG. 6 a perspective illustration of the polar plate. The known polar plate 10′ comprises a flow field plate 22′ forming a housing bottom part comprising a flow field 16′ not shown in any more detail and a blind plate 24′ forming an upper housing part. Aside from two operating means supply orifices which are of no particular relevance the blind plate 24′ comprises an access orifice 18′ accessible via the flow field 16′ as can be best seen in FIG. 6. The flow field plate 22′ and the blind plate 24′ are connected in a gas-tight manner via a welded joint not shown in any more detail. Above and/or inside of the access orifice 18′ a membrane-electrode unit 26′ is disposed which is, for example, attached to the periphery of the blind plate 24′ in a non-positive manner by means of solder glass. Additional seals, contact-generating layers, etc. which are provided in real embodiments are not shown for reasons of clarity.

The membrane-electrode unit 26′ may, for example, be primarily formed of yttrium-stabilised zirconium oxide while the polar plate 10′ can be made of ferritic steel. Materials which are so different have different expansion coefficients which lead to stress during thermal cyclising (in an SFOC fuel cell system, for example, the temperature may vary between the ambient temperature and an operating temperature of 800° C. or more). Yttrium-stabilised zirconium oxide as well as ferritic steel are, in principle, capable of endure tension and pressure stresses without any plastic deformation. The three-dimensional structure of the polar plate 10′ which is recognisable particularly in FIG. 1 and comprises narrow edges, however, leads to the possible occurrence of bending mo ments and therefore of a bending of the structure. Furthermore, withdrawal movements may occur due to the mechanical event of buckling. If the membrane-electrode unit 26′ is exposed to compressive strain, for example at ambient temperature, while the polar plate 10′ consisting of the flow field plate 22′ and the blind plate 24′ is exposed to tensile stress a bending moment occurs as shown in FIG. 4. In this case the force F resulting from the compressive and tensile stresses cooperates with a lever arm L₁. Said bending moment may lead to a deformation of the polar plate 10′ as shown in FIG. 2. The deformation shown is a relaxation of the tensions. An equilibrium will result in which lengths change as well. For example, the dimension x₂ shown in FIG. 2 is larger than the dimension x₁ shown in FIG. 1.

Deformations of repetitive units or termination units 30′ as shown in FIG. 2 may lead to a cracking of seals and/or to a breaking or sliding-off of electric contacts.

The invention is therefore based on the object to at least substantially reduce deformations of termination and/or repetitive units for fuel cell stacks during a thermal cyclising.

Said object is solved by the features of the independent claims.

Advantageous embodiments and further developments of the invention are disclosed in the dependent claims.

The polar plate according to the invention is based on the generic state of the art in that at least one flow field is accessible via a plurality of access orifices. This solution is based on the finding that the material present between the access orifices results in a stiffening of the construction and, above that, to reduced bending moments when a plurality of small access orifices are provided instead of one large access orifice. In this way, as a result, the deformation of termination and/or repetitive units is at least considerably reduced which results in an enhanced cycle strength. Since the seals will no longer crack the tightness is enhanced. Since a breaking or sliding off of electric contacts is also prevented there is a reduced contact degradation in the entire fuel cell stack, i.e. of the contacts of anode and cathode, etc.

In preferred embodiments it is contemplated that the plurality of access orifices are separated from each other by at least one or more enforcement struts. It is, for example, possible to subdivide a large rectangular or quadratic access orifice into a plurality of smaller rectangular or quadratic access orifices by means of enforcements struts disposed perpendicular to each other. In this connection it is considered as particularly advantageous that the enforcement struts are formed by the material of a so-called blind plate as discussed later in more detail.

Furthermore, it is preferable that the polar plate according to the invention comprises a flow field plate comprising the at least one flow field and a blind plate comprising the plurality of access orifices. Similar to the state of the art the flow field plate and the blind plate are connected to each other in a gas-tight manner, for example by welding.

In preferred embodiments of the polar plate according to the invention it is contemplated that it consists, at least in portions, of steel, particularly of ferritic steel. Ferritic steel is, for example, capable of withstanding temperatures as they are encountered during the operation of SOFC fuel cell systems.

Furthermore, it is preferable that for the polar plate according to the invention at least one flow field for supplying a hydrogenous working gas to a membrane-electrode unit is provided. Similar to the state of the art the membrane-electrode unit may, for example, be primarily manufactured of yttrium-stabilised zirconium oxide.

In certain embodiments of the polar plate according to the invention it is contemplated that it is an end plate. For one of the end plates of a fuel cell stack it is sufficient that it comprises a flow field for distributing the hydrogenous working gas.

In other embodiments of the polar plate according to the invention it is contemplated that it is a bipolar plate and that distributor means for supplying an oxygenic gas to another membrane-electrode unit are provided on the side of the bipolar plate opposing the access orifices. The distributor means may, for example, be formed like a channel and attached to the side of the flow field plate opposing the flow field or formed integrally with the same.

The termination unit according to the invention for a fuel cell stack may, in particular, comprise:

a polar plate in the form of an end plate for a fuel cell stack comprising at least one flow field accessible from at least one side of the end plate via a plurality of access orifices, and

a membrane-electrode unit covering the plurality of access orifices, the at least one flow field being provided for supplying a hydrogenous working gas to the membrane-electrode unit.

The repetitive unit according to the invention for a fuel cell stack may, in particular, comprise:

a polar plate in the form of a bipolar plate for a fuel cell stack comprising at least one flow field accessible from at least one side of the end plate via a plurality of access orifices, and

a membrane-electrode unit covering the plurality of access orifices,

the at least one flow field being provided for supplying a hydrogenous working gas to the membrane-electrode unit and distributor means for supplying an oxygenic gas to a further membrane-electrode unit allocated to another termination or repetitive unit being provided on the side of the bipolar plate opposing the access orifices.

Furthermore the fuel cell stack according to the invention comprises:

at least one termination unit according to the invention, and

a plurality of the repetitive units according to the invention.

Preferred embodiments of the invention will be described by way of example in more detail with reference to the allocated drawings in which:

FIG. 1 shows a cross sectional view of a termination unit according to the state of the art already explained in the introduction;

FIG. 2 shows the termination unit of FIG. 1 also already explained in the introduction in a deformed state;

FIG. 3 shows a schematic cross sectional view of an embodiment of the termination unit according to the invention;

FIG. 4 shows the detail Y of FIG. 1 already explained in the introduction;

FIG. 5 shows the detail Z of FIG. 5;

FIG. 6 shows a perspective view of a polar plate according to the state of the art already explained in the introduction;

FIG. 7 shows a perspective illustration of an embodiment of the polar plate according to the invention;

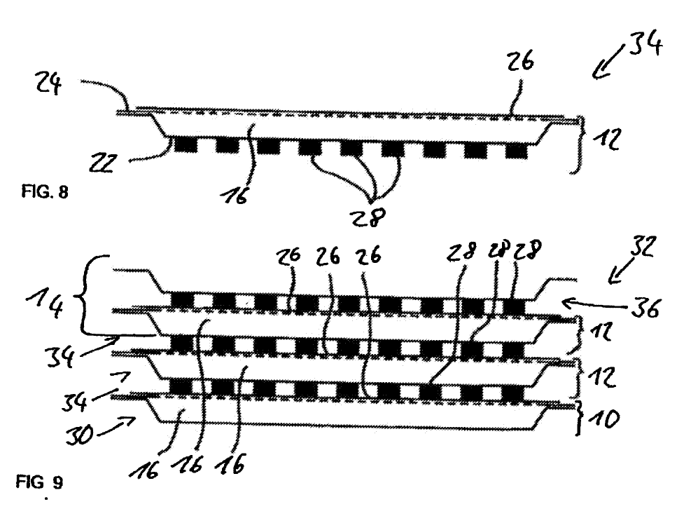

FIG. 8 shows a schematic cross sectional view of an embodiment of the repetitive unit according to the invention; and

FIG. 9 shows a schematic cross sectional view of an embodiment of the fuel cell stack according to the invention.

In the Figures the same or similar reference numerals designate the same or similar elements which will, for the avoidance of repetitions, at least partly only be explained once.

As is best recognisable by means of a comparison of FIGS. 6 and 7 the polar plate 10 according to the invention is provided with a plurality of access orifices 18 as shown in FIG. 7 instead of a single large access orifice 18′ (see FIG. 6). The plurality of access orifices 18 are, in this case, separated from each other by a plurality of enforcement struts 20 which are formed by the material of a blind plate 24. A flow field 16 formed or accommodated by a flow field plate 22 is accessible through the plurality of access orifices 18. The flow field plate 22 as well as the blind plate 24 may advantageously be formed of ferritic steel.

In FIGS. 3 and 5 the portion of the blind plate 24 forming the plurality of access orifices 18 is illustrated in broken lines. A comparison of FIGS. 4 and 5 will show that the lever arm L₂ is clearly shortened by the enforcement struts 20 as compared to the lever arm L₁. In this way a reduced bending moment acts on a structure which is, in addition, even stiffer due to the enforcement struts 20. The deformation of the termination unit 30 according to the invention (see FIG. 3) as well as the deformation of the repetitive unit according to the invention (see FIG. 8) is thus at least significantly reduced as compared to the state of the art. The repetitive unit 34 shown in FIG. 8 differs from the termination unit 30 shown in FIG. 3 in that distributor means 28 for supplying an oxygenic gas to another membrane-electrode unit are provided on the side of the flow field plate 22 opposing the flow field. Said distributor means 28 may be formed in any way well known to those skilled in the art, for example in a bridge-like manner.

The cooperation of a termination unit 30 according to the invention and two repetitive units 34 according to the invention as well as another termination unit of another design which is not of particular relevance here can be seen in FIG. 9 illustrating an embodiment of the fuel cell stack according to the invention. Here each membrane-electrode unit can be supplied with a hydrogenous working gas via a respective flow field 16 on the one side and with an oxygenic gas via respective distributor units 28 on the other side as per se known. Even though the individual components of the fuel cell stack 32 are designed asymmetrically like in the state of the art there are all in all reduced bending moments and a stiffer structure which is deformed clearly less in case of stresses caused by temperature variations as compared to the state of the art.

The features of the invention disclosed in the above description, in the drawings as well as in the claims may be important for the realisation of the invention individually as well as in any combination.

### LIST OF REFERENCE NUMERALS

10, 10′ polar plate
12 polar plate
14 fuel cell
16, 16′ flow field
18, 18′ access orifice(s)
20 enforcement struts
22, 22′ flow field plate
24, 24′ blind plate
26, 26′ membrane-electrode unit
28 distributor means
30, 30′ termination unit
32 fuel cell stack
34 repetitive unit
36 termination unit of a different design

1. A polar plate, particularly an end plate or a bipolar plate, for a fuel cell stack comprising at least one flow field accessible from at least one side of the polar plate, characterised in that the at least one flow field is accessible via a plurality of access orifices.

2. The polar plate of claim 1, characterised in that the plurality of access orifices are separated from each other by at least one or more enforcement struts.

3. The polar plate of claim 1, characterised in that it comprises a flow field plate comprising the at least one flow field and a blind plate comprising the plurality of access orifices.

4. The polar plate of claim 1, characterised in that it consists, at least in portions, of steel, particularly of ferritic steel.

5. The polar plate of claim 1, characterised in that the at least one flow field is provided for supplying a hydrogenous working gas to a membrane-electrode unit.

6. The polar plate of claim 5, characterised in that it is an end plate.

7. The polar plate of claim 5, characterised in that it is a bipolar plate and in that distributor means for supplying oxygenic gas to another membrane-electrode unit are provided on the side of the bipolar plane opposing the access orifices.

8. A termination unit for a fuel cell stack, comprising:
a polar plate of claim 6, and
a membrane-electrode unit covering the plurality of access orifices.

9. A repetitive unit for a fuel cell stack comprising:
a polar plate of claim 7, and
a membrane-electrode unit covering the plurality of access orifices.

10. A fuel cell stack comprising:
at least one termination unit, and
a plurality of repetitive units.
